(19) United States
(12) Patent Application Publication
(10) Pub. No.: US 2008/0123575 A1
(43) Pub. Date: May 29, 2008

(54) Adaptive trigger frame generation in wireless networks

(75) Inventor: Mikko Jaakkola, Lempaala (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/606,303

(22) Filed: Nov. 27, 2006

(51) Int. Cl. G08C 17/00

(52) U.S. Cl. 370/311

(57) ABSTRACT

The present invention provides a method and apparatus featuring implementing an unscheduled service period (U-SP) in a node, point, terminal or device, such as a station (STA), in a wireless local area network (WLAN), or other suitable network; and learning the application layer periodicity to enable the generation of artificial trigger frames in cases where symmetric traffic is being suppressed to optimize the unscheduled service period (U-SP). The learning may include a function to determine the natural frame-rate of the wireless local area network (WLAN), or other suitable network, where the learning includes a calculation of the voice and video streams.

### BACKGROUND OF THE INVENTION

1. Field of Invention

The present invention relates to a wireless network environment, and more particularly provides a method and system for optimizing data reception and power saving for mobile terminals operating in a wireless local area network (WLAN) environment.

In particular, the present invention relates to the field of WLAN, and more particularly to unscheduled automatic power saving scheme (U-APSD) for WLAN, wherein access points buffer data to U-APSD terminals unless the terminal indicates an active presence by sending a frame to the access point that triggers the access point to initiate a so-called active communication period and send all the buffered data to the terminal, and the terminal can thereafter enter into the power saving mode only after the access points indicates that all buffered data is transmitted to the terminal.

2. Description of Related Art

Modern society has quickly adopted, and become reliant upon, handheld devices for wireless communication. For example, cellular telephones continue to proliferate in the global marketplace due to technological improvements in both the quality of the communication and the functionality of the devices. These wireless communication devices have become commonplace for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate wireless communication over large geographic areas. These network technologies have commonly been divided by generations, starting in the late 1970s to early 1980s with first generation (1G) analog cellular telephones that provided baseline voice communication, to modern digital cellular telephones. GSM is an example of a widely employed 2G digital cellular network communicating in the 900 MHZ/1.8 GHZ bands in Europe and at 850 MHz and 1.9 GHZ in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth® is an example of a short-range wireless technology quickly gaining acceptance in the marketplace. A user does not actively instigate a Bluetooth® network. Instead, a plurality of devices within operating range of each other may automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master. These devices continually switch between various active communication and power saving modes in order to transmit data to other piconet members. In addition to Bluetooth® other popular short-range wireless networks include WLAN (of which “Wi-Fi” local access points communicating in accordance with various IEEE 802.11x standards, is an example), WUSB, UWB, ZigBee (802.15.4, 802.15.4a), and UHF RFID. All of these wireless mediums have features and advantages that make them appropriate for various applications.

In recent years, wireless LAN technology has become very popular because of its advantage in price and bandwidth. Nowadays, wireless LAN is mainly used for Internet access, but real-time application like Voice over IP (VoIP) and video on demand (Vod) are identified as the future applications for wireless LAN. To support such new applications, IEEE 802.11e was standardized to define a new 802.11 medium access control (MAC) layer protocol. The IEEE 802.11e MAC is a standard to support Quality of Service (QoS), and 802.11e Hybrid Coordination Function (HCF) can support QoS in 802.11 networks. The HCF provides both a contention-based channel access, called enhanced distributed channel access (EDCA), and a controlled channel access, referred to as HCF controlled channel access (HCCA).

Handheld devices having IEEE 802.11 WLAN can provide wireless broadband access. However, since they are generally battery-powered, power consumption is a critical issue for mobile terminals equipped with IEEE 802.11 WLAN. Therefore IEEE 802.11 provides a power saving mechanism (LegacyPS) for STAs to reduce power consumption. Furthermore, IEEE 802.11e supports scheduled and unscheduled automatic power save delivery (S-APSD and U-APSD) to enhance the power saving mechanism in LegacyPS. An access station (STA), that is user device, can determine which power saving mechanism it uses.

U-APSD is a power saving method that will be (and already is) implemented by most WLAN modem vendors. In U-APSD, the terminal (STA) initially informs the access point (AP) that it will use U-APSD, which means that the AP will buffer downlink data intended to the STA until it receives a triggering frame from the STA, which indicates to the AP that the STA is awake and a Service Period (U-APSD SP) can be started. In U-APSD SP, the AP transmits the buffered data to the STA, which is required to stay active until receiving a service period end indication from the AP and send an acknowledgement to that, after which it can enter doze/power saving state.

Under EDCA, U-APSD can achieve energy-efficient transmission because it reduces awake-period compared to LegacyPS. U-APSD has to transmit uplink frames in order to retrieve frames buffered at Quality of Service (QoS) Access Point (QAP). Those uplink frames are called trigger frames. In the case where an STA has uplink data frames (i.e. connection is bi-directional), U-APSD can save energy. However, when it does not have uplink data frames generated at a constant rate (for example, ON-OFF traffic), it has to send a null-data frame to retrieve frames buffered at QAP. When there is no uplink frame and null-data frames are rarely transmitted to the QAP, large delay and low throughput occurs even if energy can be saved. On the contrary, when there are little buffered frames at the QAP and many null-data frames are transmitted as trigger-frames, energy will be wasted. Therefore, trade-off between delay (throughput) and energy consumption must be considered to send trigger frames. Although IEEE 802.11e standard has defined the basic operation of U-APSD, how and when to start transmission of trigger frames are still dependent on a vendor's implementation.

In operation, the Qos based low-latency power-save scheme called U-APSD defined in IEEE section 802.11e enables a station to trigger frames from the WLAN AP right after the station has send a packet to it. This allows synchronization of receiving and sending frames between a terminal and a WLAN AP so that a WLAN station can go to sleep right after it receives the downlink frame. To summarize, every frame sent by the station (when it is in power-save mode and defined to use U-APSD) can trigger 0 or more frames to downlink. In principle, this allows a convenient power-efficient ping-pong type of operation at the protocol level.

However, one problem with the U-APSD scheme is that in situations when communication between the access point and the terminal is asynchronous, such as, for example in a silent suppression scheme where the terminal is not sending any data back to the access point when a user is not actively talking to the phone, the U-APSD scheme gets far from optimized as the access point buffers lots of data and when the terminal sends a triggering frame to the access point, it has to remain active for very long time to receive all the buffered data. In other words, while the U-APSD scheme is optimized to be used for symmetric traffic (e.g. normal VoIP), in the case where the silent suppression (i.e. a scheme where the station or network is not sending any data when a person is not talking during the call) is used, the U-APSD does not work that well—e.g. if the person talking on the WLAN terminal is not saying anything, the WLAN AP is not sending any audio packets back to the station but they get buffered into the WLAN AP.

In view of this, in the prior art there are known techniques for using such a WLAN implementation with a static timer to send NULL-data frames to the WLAN AP in a regular time interval, but this approach is not a very good solution as the interval of the downlink data is not known by the WLAN layers, which typically can cause a) too much latency, b) too much WLAN network traffic and c) a higher energy consumption.

Another way to handle the situation is to always generate voice traffic frames (=not to support silent suppression). This would allow generating frames at the right application layer rate. This scheme has two major disadvantages: a) Sometimes the silent suppression is a network feature that must be supported (and there are some other reasons why silent suppression is beneficial) or b) generating IP-level frames will load the core network (routers, gateways, servers).

A third way to handle the situation is to specify the actual frame-rate to the application via some special QoS API.

Furthermore, by way of example, the reader is also referred to application Ser. No. 11/395,566, filed 31 Mar. 2006, entitled “Triggering Rule For Energy Efficient Data Delivery”, Attorney docket nos. NC52159/944-4.073), which is owned by the assignee of the instant application hereby incorporated by reference in its entirety, and discloses a method or apparatus for implementing an unscheduled automatic power save delivery (U-APSD) in a wireless local area network (WLAN) terminal, comprising one or more steps for maintaining a timer for defining a triggering interval between sending of subsequent trigger frames to a WLAN access point, wherein the value of the timer is set to dynamically change according to one or more criteria relating to the current communication situation. In this technique, the criteria depend on whether there are buffered frames at another node, point, terminal or device, such as an Access Point (AP)), in the wireless local area network (WLAN), or other suitable network. For example, when there are buffered frames at the AP, the WLAN terminal sets the triggering interval to a minimum value and sends null-data frames to quickly retrieve them, or when there is no buffered frame at the AP, the STA sets the triggering interval to a larger value to continue the doze mode for a long time and to save energy. The WLAN terminal incrementally increases the triggering interval in a binary exponential fashion, including doubling it, but not exceeding a maximum value.

In view of this, there is a need for a technique for generating intelligent trigger-frames to ensure a smooth operation even in the cases where the traffic is not being symmetric.

### SUMMARY OF THE INVENTION

The present invention provides a method and apparatus featuring implementing an unscheduled power saving scheme in a node, point, terminal or device in a wireless network; monitoring application layer activity of ongoing communication to learn application layer periodicity for the communication; and generating artificial trigger frames based on the application layer periodicity when symmetric traffic is being suppressed during the unscheduled power saving scheme.

According to some embodiments of the present invention, the wireless network may include a wireless local area network (WLAN), Bluetooth® (BT), ultra wide band (UWB), wireless USB or other suitable wireless network either now known or later developed in the future.

The learning may include a function to determine the natural frame-rate of the wireless local area network (WLAN), or other suitable wireless network, where the learning includes a calculation of the voice and video streams.

In operation, after a trigger period, the artificial trigger-frame, including a Qos Null-dataframe, is sent if no normal frame is transmitted by the terminal, so as to allow the node, point, terminal or device to mimic symmetric behaviour in cases where terminal higher layer protocols are not generating any frames at the natural frame rate. A learning sequence can be initiated to determine possible changes in the frame rates if there are no frames received for trigger-frames. The learning may include determining the natural frame-rate of the wireless local area network (WLAN), or other suitable wireless network so as to control the generation of trigger frames.

The method according to some embodiments of the present invention may include activating the learning function when the WLAN subsystem, including the node, point, terminal or device, is transferred from a power-save mode to an active mode and when the node, point, terminal or device is transmitting traffic.

Moreover, the method may include dividing the calculations into QoS buckets so that periodicity is defined per QoS-stream (including voice, video, background and best-effort) in order to make calculations.

The transmit side packet calculation can be typically carried out either in a power-save or an active mode, including when the node, point, terminal or device moves into the active-mode as the natural flow of the packet transfers is resumed, and may include adding the receive-path into calculations.

The periodicity calculation algorithm may include using a predetermined number of bucket queues, including one queue per QoS class, which each has a predetermined number of buckets divided in an interval of a predetermined amount of time starting from a first bucket containing all the incidents where the time between consecutive frames is in a predetermined interval of tome, a second bucket containing a number of frames received in a subsequent predetermined interval of time, etc.

After the learning period, the node, point, terminal or device may assume that the bucket having the most samples represents the right period for the traffic.

The method may also include doing the calculations separately for a transmit-path and receive-path to determine possible asymmetrises in the traffic-patterns and then afterwards merging together if patterns look similar in both samples.

The present invention may also include implementing the method in apparatus such as, for example, a node, point, terminal or device, such as a station (STA), in a system having such a wireless network, including a wireless local area network (WLAN), that features monitoring application layer activity of ongoing communication to learn application layer periodicity for the communication, and generating artificial trigger frames based on the application layer periodicity when symmetric traffic is being suppressed during the unscheduled power saving scheme, including. The unscheduled power saving scheme may include an unscheduled service period (U-SP), such as an unscheduled automatic power save delivery (U-APSD) as defined in IEEE 802.11e, as well as other unscheduled automatic power save delivery techniques either now known or later developed in the future.

The scope of the invention may also include implementing the same in a computer program product with a program code, which program code is stored on a machine readable carrier, for carrying out the steps of the method according to the present invention. The method may also feature implementing the step of the method via a computer program running in a processor, controller or other suitable module in such a WLAN terminal.

Furthermore, the scope of the invention is also intended to include a method, apparatus, system and computer program for facilitating communication in a wireless local area network, featuring monitoring characteristics of at least transmissions of data when operating certain applications; and triggering transmission of non-payload frames based on the monitored characteristics of the at least transmissions of data when operating said applications in asymmetric power saving mode.

One important difference between the present invention and application Ser. No. 11/395,566 in that the system in the '566 application is trying to adjust according to current traffic situations as they arrive, while the present invention is trying to provide a good estimation on what the traffic situation would be according to typical communication situations with certain applications especially in silent suppression situations.

The present invention provides solutions for generating intelligent trigger-frames to ensure a smooth operation even in the cases where the traffic is not being symmetric.

### BRIEF DESCRIPTION OF THE DRAWING

The drawing includes the following Figures, which are not necessarily drawn to scale:

FIG. 1 shows typical parts of an IEEE 802.11 WLAN system according to some embodiments of the present invention.

FIG. 2 shows a flow chart of the basic steps of some embodiments of the present invention.

FIG. 3 shows a WLAN enabled device according to some embodiments of the present invention.

FIG. 4 shows an exemplary WLAN chip that forms part of the WLAN enabled device shown in FIG. 3 according to some embodiments of the present invention.

FIGS. 5a and 5b show diagrams of the Universal Mobile Telecommunications System (UMTS) packet network architecture according to some embodiments of the present invention.

### BEST MODE OF THE INVENTION

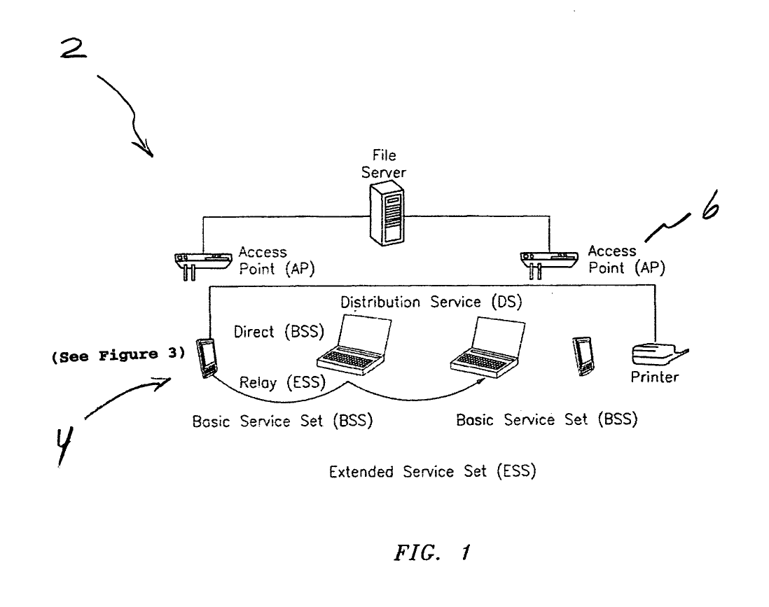

FIG. 1 shows, by way of example, a wireless network according to the present invention in the form of an IEEE 802.11 WLAN system, generally indicated as 2, which provides for communications between communications equipment such as mobile and secondary devices generally indicated as 4, including personal digital assistants 4a (PDAs), laptops 4b and printers 4c, etc. The WLAN system 2 may be connected to a wired LAN system that allows wireless devices to access information and files on a file server or other suitable device or connecting to the Internet. The devices can communicate directly with each other in the absence of a base station in a so-called “ad-hoc” network, or they can communicate through a base station, called an access point (AP) in IEEE 802.11 terminology, generally indicated as 6, with distributed services through the AP 2 using local distributed services (DS) or wide area extended services, as shown. In a WLAN system, end user access devices are known as stations 4 (STAs), which are transceivers (transmitters/receivers) that convert radio signals into digital signals that can be routed to and from communications device and connect the communications equipment to access points (APs) that receive and distribute data packets to other devices and/or networks. The STAs 4 may take various forms ranging from wireless network interface card (NIC) adapters coupled to devices to integrated radio modules that are part of the devices, as well as an external adapter (USB), a PCMCIA card or a USB Dongle (self contained), which are all known in the art. It is important to note that the scope of the invention is intended to include implementing the same in other types or kinds of wireless networks, including wireless short-range communication networks like Bluetooth® (BT), ultra wide band (UWB), wireless USB or other suitable wireless networks either now known or later developed in the future.

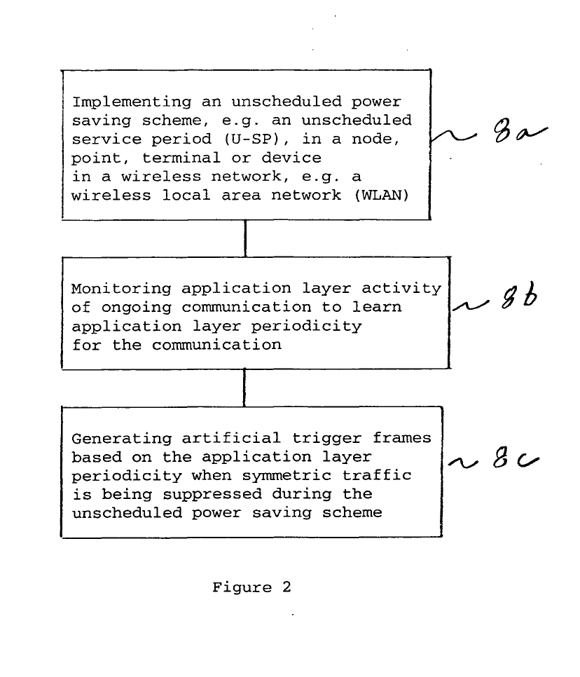

FIG. 2 shows a flowchart generally indicated as 8 having steps 8a, 8b and 8c for implementing the inventive method according to some embodiments of the present invention.

### The Basic Implementation

The whole thrust of the present invention here is to provide the terminal with a WLAN trigger-frame generation engine with means to learn the application layer periodicity to enable generation of artificial trigger frames in cases where the symmetric traffic is being suppressed (e.g. silent suppression in VoIP). The purpose of the learning function is to determine the natural frame-rate of the system to allow accurate controlling of the trigger frame generation engine. Typically, only voice and video streams needs to be calculated as there the latency requirements are toughest for such applications.

In operation, the frame-trigger generation engine may be used so that a trigger-frame (e.g. a Qos Null-dataframe in this case) is sent after a trigger period if no normal frame is transmitted by the terminal. This allows the terminal to mimic symmetric behaviour in the cases, where terminal higher layer protocols are not generating any frames at the natural frame rate. If the frame-trigger generation engine notices that there are no frames received for its trigger-frames, then it can initiate a learning sequence to determine possible changes in the frame rates.

The implementation includes two different functions—one being the learning function and the other being the trigger frame generation engine.

The learning function may be activated when the WLAN subsystem is transferred from the power-save mode to the active mode and when the terminal is transmitting traffic. To make calculations more accurately, the terminal may divide the calculations into QoS buckets so that periodicity is defined per QoS-stream (voice, video, background & best-effort). Typically, only voice and video streams needs to be calculated as there the latency requirements are tougher but some legacy implementations may also benefit, including calculations of periodicity in other traffic classes as well.

The transmit side packet calculation can be typically carried out either in the power-save or active mode but the most reliable calculations can be performed when the subsystem moves in the active-mode as the natural flow of the packet transfers is resumed. The transmitted traffic internal usually gives a pretty good hint what the symmetric period is but adding the receive path into calculations make the results more accurate.

The scope of the invention is not intended to be limited to method of comparing the time interval between consecutive frames, but there does exist a lot of methods for pattern matching but to make this implementation part more informative a ‘reference’ implementation is described here.

By way of example, the periodicity calculation algorithm could be such that there are four bucket queues (e.g. one queue per QoS class), which each has 10 buckets divided in an interval of 10 ms starting from bucket 0 containing all the incidents where the time between consecutive frames is between 1-10 ms. The bucket 1 contains a number of frames received between 11-20 ms interval and so. After the learning period, the system assumes that the bucket having the most samples does represent the right period for the traffic. These calculations can be done separately for transmit- and receive-path to determine possible asymmetrises in the traffic-patterns and then afterwards merged together if patterns look similar in both samples. The actual details about using QoS is not discussed here more than just mentioning that voice and video streams might be the only ones that might be worth taking into calculations. Also the shortest period of the each queue is a good guess for the global QoS-queue agnostic trigger-frame rate. While this embodiment is provided by way of example, the scope of the invention is not intended to be limited to the same, because other embodiments are envisioned within the scope of the invention.

The frame-trigger generation engine may be used so that the trigger-frame (Qos Null-dataframe in this case) is sent after a predefined trigger period if no normal frame is transmitted by the terminal. This allows terminal to mimic symmetric behaviour in the cases, where terminal higher layer protocols are not generating any frames at the natural frame rate. If the frame-trigger generation engine notices that there are no frames received for its trigger-frames, then it can initiate a learning sequence to determine possible changes in the frame rates.

The present invention reduces power-consumption in those cases, where the native period and data-traffic periodicity do not match; increases WLAN network capacity as unnecessary trigger frames do not get generated; and provides the ability to adjust the system to asymmetric voice traffic where down-stream and up-stream packet rates do not match. Moreover, there is no loading of the core network. Moreover still, there is also no need for applications to specify frame-rate to the WLAN subsystem. In many cases, this would not even be possible as most operating systems do not support such a feature. The present invention is also backwards compatible with legacy applications.

### Device Implementation

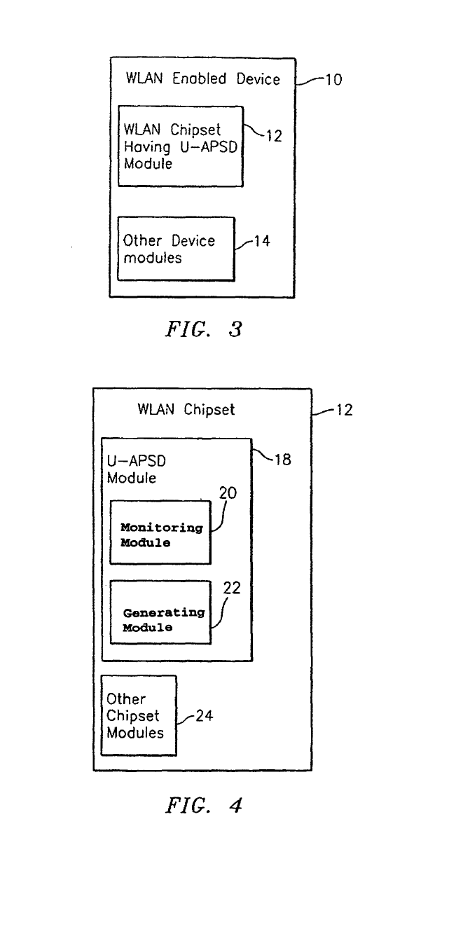

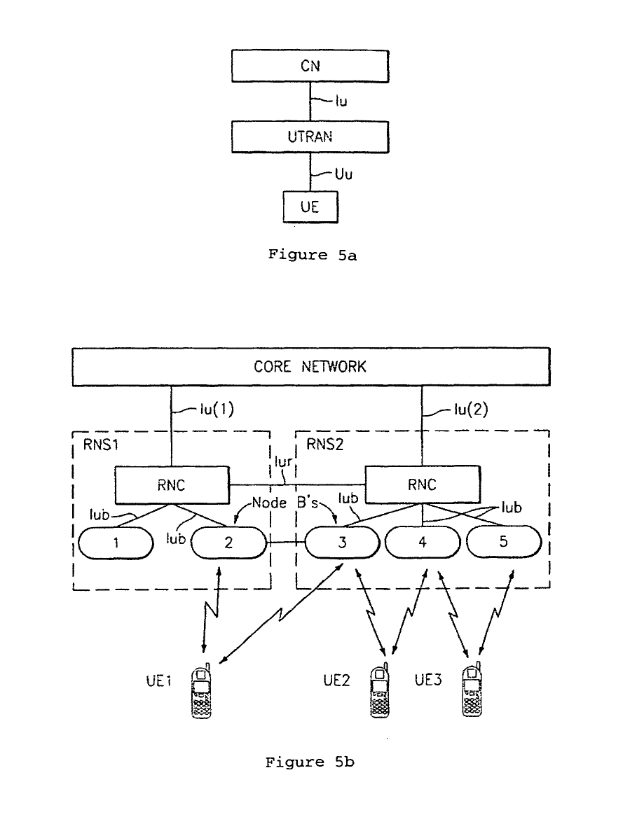

FIG. 3 shows a node, point, terminal or device 4 in the form of a WLAN enabled device generally indicated 10 according to one embodiment of the present invention for a wireless local area network (WLAN) or other suitable network such as that shown in FIGS. 1, 5a and 5b. The WLAN enabled device 10 has a WLAN chipset 12 having a U-APSD module 18 (see FIG. 4) configured for implementing an unscheduled service period (U-SP) in the node, point, terminal or device, such as the station (STA) 4 in FIG. 1, in the wireless local area network (WLAN) 2 in FIG. 1, or other suitable network, according to some embodiments of the present invention, as well as other device modules 14. The WLAN enabled device 10 may take the form of a station (STA) or other suitable node, point, terminal or device either now known or developed in the future for operating in such a wireless local area network (WLAN) or other suitable network such as that shown in FIGS. 1, 5a and 5b.

FIG. 4 shows, by way of example, the WLAN chipset 12 in further detail, where the U-APSD module 18 includes one or more modules configured for implementing an unscheduled power saving scheme in a node, point, terminal or device in such a WLAN, such as a monitoring module 20 configured for monitoring application layer activity of ongoing communication to learn application layer periodicity for the communication, as well as a generating module 22 for generating artificial trigger frames based on the application layer periodicity when symmetric traffic is being suppressed during the unscheduled power saving scheme according to one embodiment of the present invention. In operation, the modules 20 and 22 cooperate consistent with that shown and described herein for both monitoring and learning the application layer periodicity to enable the generation of artificial trigger frames in cases where symmetric traffic is being suppressed to optimize the unscheduled service period (U-SP) and for performing the functionality related to the trigger frame generation engine, including generation of the artificial trigger frames, according to some embodiments of the present invention. The WLAN chipset 12 may also include other chipset modules 24 that do not necessarily form part of the underlying invention and are not described in detail herein, including a baseband module, a MAC module, a host interface module. Although the present invention is described in the form of a stand alone module for the purpose of describing the same, the scope of the invention is invention is intended to include the functionality of the U-APSD module 18 being implemented in whole or in part by one or more of these other chipset modules 24. In other words, the scope of the invention is not intended to be limited to where the functionality of the present invention is implemented in the WLAN chipset 12.

### Implementation of the Functionality of U-APSD Module 18

By way of example, and consistent with that described herein, the functionality of the U-APSD module 18 may be implemented using hardware, software, firmware, or a combination thereof, although the scope of the invention is not intended to be limited to any particular embodiment thereof. In a typical software implementation, the module 18 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the module 18 being a stand alone module, as shown, or in the combination with other circuitry for implementing another module. Moreover, the real-time part may be implemented in hardware, while non real-time part may be done in software.

The other chipset modules 24 may also include other modules, circuits, devices that do not form part of the underlying invention per se. The functionality of the other modules, circuits, device that do not form part of the underlying invention are known in the art and are not described in detail herein.

### The WLAN Chipset

The present invention may also take the form of the WLAN chipset 12 for a node, point, terminal or device in a wireless local area network (WLAN) or other suitable network, that may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

### Universal Mobile Telecommunications System (UMTS) Packet Network Architecture

FIGS. 5a and 5b show diagrams of the Universal Mobile Telecommunications System (UMTS) packet network architecture. In FIG. 5a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 5b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 5a. A given UE may be in radio contact with multiple Node Bs even if one or more of the Node Bs are connected to different RNCs. For instance, a UE1 in FIG. 5b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 5a and 5b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 5a and 5b is being defined at present in protocol specifications for 3GPP and 3GPP2. The scope of the invention is intended to include implementing the same in such a UMTS packet network architecture as shown in FIGS. 5a and 5b.

### List of Abbreviations

### QSTA: QoS Station

### QAP: QoS Access Point

### U-APSD: Unscheduled Automatic Power Save Delivery

### SP: Service Period

### EOSP: End of Service Period

### EDCA: Enhanced Distributed Channel Access

### U-SP: Unscheduled Service Period

### STA: Access Station

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method comprising:
implementing an unscheduled power saving scheme in a node, point, terminal or device in a wireless network;
monitoring application layer activity of ongoing communication to learn application layer periodicity for the communication; and
generating artificial trigger frames based on the application layer periodicity when symmetric traffic is being suppressed during the unscheduled power saving scheme.

2. A method according to claim 1, wherein the wireless network includes a wireless local area network (WLAN).

3. A method according to claim 2, wherein the unscheduled power saving scheme includes an unscheduled service period (U-SP) for the WLAN.

4. A method according to claim 1, wherein the learning includes a function to determine the natural frame-rate of the wireless network.

5. A method according to claim 1, wherein the learning includes a calculation of the voice and video streams.

6. A method according to claim 1, wherein, after a trigger period, sending the artificial trigger-frame, including a Qos Null-dataframe, if no normal frame is transmitted by the terminal, so as to allow the node, point, terminal or device to mimic symmetric behaviour in cases where terminal higher layer protocols are not generating any frames at the natural frame rate.

7. A method according to claim 1, wherein a learning sequence can be initiated to determine possible changes in the frame rates if there are no frames received for trigger-frames.

8. A method according to claim 1, wherein the learning includes determining the natural frame-rate of the wireless network so as to control the generation of trigger frames.

9. A method according to claim 1, wherein the method includes activating the learning function when the wireless network subsystem, including the node, point, terminal or device, is transferred from a power-save mode to an active mode and when the node, point, terminal or device is transmitting traffic.

10. A method according to claim 1, wherein the method includes dividing the calculations into QoS buckets so that periodicity is defined per QoS-stream (including voice, video, background and best-effort) in order to make calculations.

11. A method according to claim 1, wherein the transmit side packet calculation can be typically carried out either in a power-save or an active mode, including when the node, point, terminal or device moves into the active-mode as the natural flow of the packet transfers is resumed.

12. A method according to claim 1, wherein the method includes adding the receive-path into calculations.

13. A method according to claim 1, wherein the periodicity calculation algorithm includes using a predetermined number of bucket queues, including one queue per QoS class, which each has a predetermined number of buckets divided in an interval of a predetermined amount of time starting from a first bucket containing all the incidents where the time between consecutive frames is in a predetermined interval of tome, a second bucket containing a number of frames received in a subsequent predetermined interval of time, etc.

14. A method according to claim 13, wherein, after the learning period, the node, point, terminal or device assumes that the bucket having the most samples represents the right period for the traffic.

15. A method according to claim 1, wherein the method includes doing the calculations separately for a transmit-path and receive-path to determine possible asymmetrises in the traffic-patterns and then afterwards merging together if patterns look similar in both samples.

16. A node, point, terminal or device, comprising:
a module configured for implementing an unscheduled power saving scheme in a wireless network (WLAN);
a module configured for monitoring application layer activity of ongoing communication to learn application layer periodicity for the communication; and
a module for generating artificial trigger frames based on the application layer periodicity when symmetric traffic is being suppressed during the unscheduled power saving scheme.

17. A node, point, terminal or device according to claim 16, wherein the wireless network includes a wireless local area network (WLAN).

18. A node, point, terminal or device according to claim 17, wherein the unscheduled power saving scheme includes an unscheduled service period (U-SP) for the WLAN.

19. A node, point, terminal or device according to claim 16, wherein the learning includes a function to determine the natural frame-rate of the wireless network.

20. A node, point, terminal or device according to claim 16, wherein the learning includes a calculation of the voice and video streams.

21. A node, point, terminal or device according to claim 16, wherein, after a trigger period, the module configured for learning sends a trigger-frame if no normal frame is transmitted by the terminal, so as to allow the node, point, terminal or device to mimic symmetric behaviour in cases where terminal higher layer protocols are not generating any frames at the natural frame rate.

22. A node, point, terminal or device according to claim 16, wherein a learning sequence can be initiated to determine possible changes in the frame rates if there are no frames received for trigger-frames.

23. A node, point, terminal or device according to claim 16, wherein the learning includes determining the natural frame-rate of the wireless network so as to control the generation of trigger frames.

24. A node, point, terminal or device according to claim 16, wherein the method includes activating the learning function when the wireless network, including the node, point, terminal or device, is transferred from a power-save mode to an active mode and when the node, point, terminal or device is transmitting traffic.

25. A node, point, terminal or device according to claim 16, wherein the method includes dividing the calculations into QoS buckets so that periodicity is defined per QoS-stream (including voice, video, background and best-effort) in order to make calculations.

26. A node, point, terminal or device according to claim 16, wherein the transmit side packet calculation can be typically carried out either in a power-save or an active mode, including when the node, point, terminal or device moves into the active-mode as the natural flow of the packet transfers is resumed.

27. A node, point, terminal or device according to claim 16, wherein the method includes adding the receive-path into calculations.

28. A node, point, terminal or device according to claim 16, wherein the periodicity calculation algorithm includes using a predetermined number of bucket queues, including one queue per QoS class, which each has a predetermined number of buckets divided in an interval of a predetermined amount of time starting from a first bucket containing all the incidents where the time between consecutive frames is in a predetermined interval of tome, a second bucket containing a number of frames received in a subsequent predetermined interval of time, etc.

29. A node, point, terminal or device according to claim 28, wherein, after the learning period, the module configured for learning assumes that the bucket having the most samples represents the right period for the traffic.

30. A node, point, terminal or device according to claim 16, wherein the module configured for learning includes doing the calculations separately for a transmit-path and receive-path to determine possible asymmetrises in the traffic-patterns and then afterwards merging together if patterns look similar in both samples.

31. A system comprising:
a wireless network having a node, point, terminal or device, such as a station (STA);
the node, point, terminal or device comprising:
a module configured for implementing an unscheduled power saving scheme in a wireless network;
a module configured for monitoring application layer activity of ongoing communication to learn application layer periodicity for the communication; and
a module for generating artificial trigger frames based on the application layer periodicity when symmetric traffic is being suppressed during the unscheduled power saving scheme.

32. A system according to claim 31, wherein the wireless network includes a wireless local area network (WLAN).

33. A system according to claim 32, wherein the unscheduled power saving scheme includes an unscheduled service period (U-SP) for the WLAN.

34. A system according to claim 31, wherein the learning includes a function to determine the natural frame-rate of wireless network.

35. A system according to claim 31, wherein the learning includes a calculation of the voice and video streams.

36. A system according to claim 31, wherein, after a trigger period, sending a trigger-frame if no normal frame is transmitted by the terminal, so as to allow the node, point, terminal or device to mimic symmetric behaviour in cases where terminal higher layer protocols are not generating any frames at the natural frame rate.

37. A system according to claim 31, wherein a learning sequence can be initiated to determine possible changes in the frame rates if there are no frames received for trigger-frames.

38. A system according to claim 31, wherein the learning includes determining the natural frame-rate of the wireless network so as to control the generation of trigger frames.

39. A system according to claim 31, wherein the method includes activating the learning function when the wireless network subsystem, including the node, point, terminal or device, is transferred from a power-save mode to an active mode and when the node, point, terminal or device is transmitting traffic.

40. A system according to claim 31, wherein the method includes dividing the calculations into QoS buckets so that periodicity is defined per QoS-stream (including voice, video, background and best-effort) in order to make calculations.

41. A system according to claim 31, wherein the transmit side packet calculation can be typically carried out either in a power-save or an active mode, including when the node, point, terminal or device moves into the active-mode as the natural flow of the packet transfers is resumed.

42. A system according to claim 31, wherein the method includes adding the receive-path into calculations.

43. A system according to claim 31, wherein the periodicity calculation algorithm includes using a predetermined number of bucket queues, including one queue per QoS class, which each has a predetermined number of buckets divided in an interval of a predetermined amount of time starting from a first bucket containing all the incidents where the time between consecutive frames is in a predetermined interval of tome, a second bucket containing a number of frames received in a subsequent predetermined interval of time, etc.

44. A system according to claim 43, wherein, after the learning period, the node, point, terminal or device assumes that the bucket having the most samples represents the right period for the traffic.

45. A system according to claim 31, wherein the method includes doing the calculations separately for a transmit-path and receive-path to determine possible asymmetrises in the traffic-patterns and then afterwards merging together if patterns look similar in both samples.

46. A computer program product with a program code, which program code is stored on a machine readable carrier, for carrying out the steps of a method comprising one or more steps for implementing an unscheduled power saving scheme in a node, point, terminal or device in a wireless network, monitoring application layer activity of ongoing communication to learn application layer periodicity for the communication, and generating artificial trigger frames based on the application layer periodicity when symmetric traffic is being suppressed during the unscheduled power saving scheme, when the computer program is run in a module of either a node, point, terminal or device, such as a station (STA).

47. A method according to claim 1, wherein the method further comprises implementing the step of the method via a computer program running in a processor, controller or other suitable module in one or more network nodes, points, terminals or elements in the wireless LAN network.

48. Apparatus comprising:
means for implementing an unscheduled service power saving scheme in a wireless network;
means for monitoring application layer activity of ongoing communication to learn application layer periodicity for the communication; and
means for generating artificial trigger frames based on the application layer periodicity when symmetric traffic is being suppressed during the unscheduled power saving scheme.

49. A method for facilitating communication in a wireless local area network, comprising:
monitoring characteristics of at least transmissions of data when operating certain applications; and
triggering transmission of non-payload frames based on the monitored characteristics of the at least transmissions of data when operating said applications in asymmetric power saving mode.
